(19) United States
(12) Patent Application Publication
(10) Pub. No.: US 2026/0304175 A1
(43) Pub. Date: Oct. 1, 2026

(54) APPARATUS AND METHOD FOR DISTRIBUTION REPORTING IN WIRELESS COMMUNICATION SYSTEMS

(71) Applicant: Google LLC, MOUNTAIN VIEW, CA (US)

(72) Inventors: Jibing WANG, San Jose, CA (US); Erik STAUFFER, Sunnyvale, CA (US)

(21) Appl. No.: 19/633,339

(22) Filed: Mar. 30, 2026

Related U.S. Application Data
(60) Provisional application No. 63/780,880, filed on Mar. 31, 2025.

(51) Int. Cl. H04W 24/08; H04B 7/0456

(52) U.S. Cl. CPC H04W 24/08; H04B 7/0456

(57) ABSTRACT

Methods and devices in a wireless network enable the use of an artificial intelligence or machine learning model for beam management based on an estimated distribution. A user equipment (UE) receives, from a network entity (NE), a control signaling for configuring a distribution to be estimated by the UE and a channel measurement resource. The UE estimates the distribution based on measuring a downlink reference signal received on the channel measurement resource, and transmits to the NE, an indication of the estimated distribution.

### FIELD OF THE DISCLOSURE

This document generally describes methods and devices operating in wireless communication systems such as (but not limited to) the ones described in 5G standard documents, known as 3^{rd} Generation Partnership Project (3GPP) communication systems. The methods and devices are directed to applying a machine learning model to a reported distribution.

### BACKGROUND

This background description is provided for the purpose of generally presenting the context of the disclosure and the technical problems. Work of the presently named inventors, to the extent it is described in this background section, as well as aspects of the description that may not otherwise qualify as prior art at the time of filing, are neither expressly nor impliedly admitted as prior art against the present disclosure.

With the progress of machine learning (ML) and/or artificial intelligence (AI) models, various aspects of the 5G communication are enhanced by the use of such models. An ML/AI model may be deployed at a network entity (NE), which is part of the radio access network (RAN), a core network (CN), or distributed at the RAN and CN. Various models are in use today and may be deployed by the NE.

The NE may calculate a codebook for multiple-input multiple-output (MIMO) channels or beamforming for user equipment (UE) communication. To achieve the best codebook, the NE uses one or more measurements, performed at the UE, on one or more reference signals (RSs). The same or different measurements of the RSs may be used for calculating a beam direction (e.g., beam management) or predicting a channel between the UE and the NE. However, when not enough measurements are available, the NE may not provide the best codebook, or may not find the best beam direction, or may not accurately predict the channel.

No matter which model is deployed at the NE, the model needs feedback information from the UE for performing one or more related calculations. How to estimate the feedback information based on these measurements and how to report the estimate have not been established in the 3GPP communication systems.

### SUMMARY

According to an embodiment, an NE is configured to use an ML model (e.g., generative model) for MIMO and/or beamforming operations. The ML model may provide channel information, not available from UE measurements, for beam management. To provide such channel information, the ML model needs to receive at least one distribution that is estimated based on one or more measurements performed by the UE. The at least one distribution is associated with at least one of: MIMO channels, a beam direction, or a channel prediction. The NE configures the UE with at least one of a codebook associated with the at least one distribution, a configuration of a reference signal to be measured for estimating the at least one distribution, a report configuration for the indication, or an ML model selected by the NE.

The UE, after performing the measurements, transmits to the NE an indication of the estimated at least one distribution. In one embodiment, the indication may include a first index of a mean vector and a second index for a covariance matrix. The mean vector and the covariance matrix define the at least one distribution. In one variation of this embodiment, the indication further includes a third index of a weight vector. The mean vector and the covariance matrix may be associated with a Gaussian distribution. The mean vector, the covariance matrix, and the weight vector may be associated with a Gaussian mixture.

The ML model at the NE uses the estimated distribution to generate additional information about at least one of: MIMO channels, a beam direction, or a channel prediction. A similar or different ML model may be used at the UE for estimating the at least one distribution.

### BRIEF DESCRIPTION OF THE DRAWINGS

The accompanying drawings, which are incorporated in and constitute a part of the specification, illustrate one or more embodiments and, together with the description, explain these embodiments.

FIG. 1 illustrates a block diagram of a wireless communication system including the NE and the UE that perform methods according to various embodiments.

FIG. 2 illustrates a signal diagram for applying an ML model at the NE for downlink (DL) scheduling, based on measurements of a distribution performed by the UE, according to an embodiment.

FIG. 3 illustrates a signal diagram for applying an ML model at the NE for DL beamforming, based on measurements of a distribution performed by the UE, according to an embodiment.

FIG. 4 illustrates a signal diagram for applying an ML model at the NE for uplink (UL) scheduling, based on measurements of a distribution performed by the UE, according to an embodiment.

FIG. 5 is a flow chart of a method performed by the UE for estimating a distribution and reporting the estimated distribution to the NE, according to an embodiment.

FIG. 6 is a flow chart of a method performed by an NE, with an ML model, for executing a task, based on a received estimated distribution from the UE, according to an embodiment.

### DETAILED DESCRIPTION

Methods and devices described in this section embody techniques related to a UE estimating a distribution and reporting the distribution to the NE as a distribution indication. The NE is configured to use one or more ML models, for example, a diffusion model, to optimize one or more aspects of the network, such as DL beamforming and/or MIMO-related operations. For the ML model to work at the NE, the ML model needs to receive, from the UE, feedback related to the one or more distributions. The distributions are estimated based on data measurements performed or obtained by the UE.

In one embodiment, the NE uses the ML model (e.g., a generative model) to generate MIMO channels to obtain the best codebook for MIMO/beamforming. In another embodiment, the ML model may be used to generate the best beam direction based on channel state information (CSI) feedback. For this scenario, the NE may predict the channel between the NE and the UE for a future time. The NE may use the ML model to optimize a UE mobility (e.g., handover), by generating a channel to the UE and loading conditions of a serving cell and neighbor cells.

For employing an ML model, the model needs to be trained so that the ML model “learns” from past scenarios to be able to predict a new scenario. For the embodiments discussed in this document, it is assumed that the ML model is already trained. Thus, the next embodiments refer to the inference phase of using the ML model. The ML model used by the NE in the following embodiments may use deep neural networks (DNNs) as its underlying architecture to learn patterns from existing data and generate new, similar data, thus creating original content based on the learned patterns. In other words, the DNN serves as a building block for an ML model. As the structure of the DNN is known in the art, its description is omitted in this document.

Assuming that the NE hosts a trained ML model (simply called “ML model” in this document), the ML model needs to receive a certain distribution, which is estimated by the UE. This distribution makes the underlying DNN capable of predicting new content. Therefore, the NE and/or the CN need to configure how the distribution is reported by the UE to the NE, for example, via vector quantization. In one embodiment, a codebook is configured by the NE and sent to the UE for the distribution feedback.

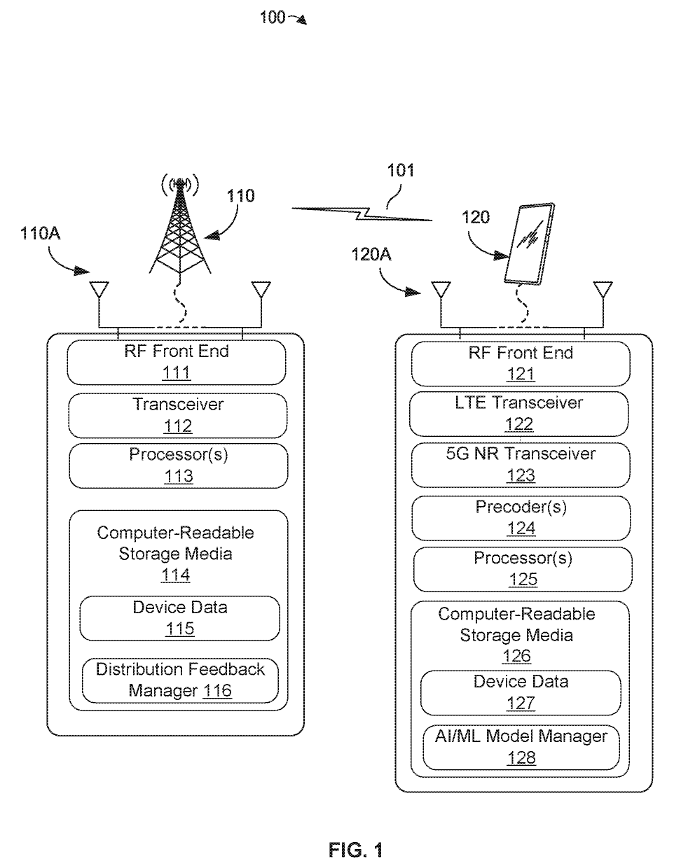

Prior to discussing UE’s distribution information reporting to the NE, a wireless communication system 100 is introduced, as illustrated in FIG. 1. The wireless communication system 100 includes an NE 110 and a UE 120 (only one of each is shown for simplicity, but one skilled in the art would understand that many such elements may be present) communicating wirelessly through a wireless communication channel 101.

NE 110 may provide the functionality of a next generation node B (gNB, e.g., a 5G or 6G base station) or perform various other CN functions. NE 110’s functionality may be distributed across multiple entities (e.g., a central unit (CU), a distributed unit (DU), and a radio unit (RU) if the NE is the BS; however, none of these units are shown in the figures). When NE 110 performs RU functionality, it includes one or more antenna panels 110A, an RF front end 111, and a transceiver 112 for communicating with the UE 120 and other UEs and NEs. NE 110’s antenna panels 110A and RF front end 111 may be tuned to one or more frequency bands (e.g., subcarriers), for example, as defined by 3GPP long term evolution (LTE), 5G new radio (NR), and 6G communication standards and implemented by transceiver 112.

NE 110 further includes processor(s) 113 and computer-readable storage media (CRSM) 114. Processor(s) 113 can include single or multiple-core processors, and CRSM 114 includes any suitable memory/storage except propagating signals. For example, memory/storage can include random access memory (RAM), static RAM (SRAM), dynamic RAM (DRAM), non-volatile RAM (NVRAM), read-only memory (ROM), and/or flash memory. CRSM 114 stores device data 115, which includes network scheduling data, radio resource management data, applications, and/or an operating system, which are executable by processor(s) 113 to enable wireless communication 101 with UE 120 as well as with other NEs and UEs. CRSM 114 also stores a distribution feedback manager 116. The distribution feedback manager 116 is configured to process a distribution associated with one or more beam conditions (e.g., beam angle) for MIMO/beamforming, UL scheduling, DL scheduling, etc., to configure the UE to estimate the distribution, and to configured the UE to feedback the distribution to the NE.

The UE 120 may be any user computing device, for example, a smartphone. The UE includes antenna panels 120A connected to an RF front end 121, and a transceiver. The transceiver may be an LTE transceiver 122, a 5G NR transceiver 123, or another transceiver. Although FIG. 1 shows two transceivers being present in the UE 120, one skilled in the art would understand that, while at least one transceiver is present, more than one transceiver being present is optional. The antenna panels 120A and RF front end 121 may be tuned to one or more frequency bands (e.g., subcarriers), for example, as defined by 3GPP LTE, 5G NR, and 6G communication standards and implemented by respective transceivers. UE 120 also includes one or more precoders 124 (that may apply a codebook), one or more processor(s) 125, and computer-readable storage media (CRSM) 126. Processor(s) 125 may be single or multiple-core processors, and CRSM 126 includes any suitable memory/storage other than propagating signals. For example, memory/storage can include RAM, SRAM, DRAM, NVRAM, ROM, and/or flash memory. CRSM 126 stores device data 127 for UE’s communications. The CRSM 126 may also include an AI/ML model manager 128. The AI/ML model manager 128 may be configured to estimate one or more distributions based on a network configuration. The network configuration may determine which specific ML model is used. In one embodiment, the NE uses a first ML model and the UE uses a second ML model, different from the first ML model. In another embodiment, the first and second ML models are identical. In yet another embodiment, at least one of the NE and UE may choose one ML model from multiple ML models. The first and second ML models may be used for different calculations by the NE and UE, i.e., the NE may use the first ML model to generate new channels with the UE and the UE may use the second ML model to estimate the distribution. The network configuration received by the UE from the NE may indicate a configuration of the distribution and a codebook to feedback the one or more distributions to the NE.

As discussed above, the NE and UE may use any ML model. According to an embodiment, an ML model is a diffusion model. The diffusion model includes two processes, a forward diffusion process of adding noise to the original data (e.g., an image, a number of communication channels, etc.) followed by a reverse diffusion process for denoising. During the forward diffusion process, the original data experiences multiple steps, where a Gaussian noise is added at each step. The final diffused data approximates a pure Gaussian noise. However, because the Gaussian noise added at each step is known and controlled, a reverse diffusion process is possible to be applied to the final diffused data and either regenerate the original data or generate new data. For the reverse diffusion process, the DNN is trained to denoise the final diffused data, by predicting the noise added in each step during the forward diffusion process. For this process, the mean value and the standard deviation of the added noise are learned by the DNN. Next, a Gaussian noise with the learned mean value and the standard deviation are used on each step to generate the output of the previous step. In this way, new data (i.e., new elements of the distribution, in addition to the samples estimated by the UE) may be generated, in addition to recovering the original data. While the diffusion model discussed in this section uses a Gaussian noise, it is possible to use other type of noises, for example, a Gaussian mixture. A Gaussian mixture is a sum of distinct Gaussian distributions, each distribution weighted with a specific weight.

A distribution may be related to one or more parameters or characteristics of the communication system 100 illustrated in FIG. 1. For example, the NE 110 may be configured to use an ML model to predict the channels between the NE and UE, or how these channels evolve in time. To be able to make such predictions, the ML model used by the NE 110 needs to know samples of a distribution of the channels. To obtain information about these samples, in one embodiment, the NE may ask the UE to measure one or more parameters (related to the channels) and determine the samples. Then, the UE estimates the distribution of the samples and transmits the distribution (or an indication of the distribution) to the NE for calculations. Note that the measurements performed by the UE may not be the samples. In other words, the UE may use itself an ML model to generate the samples (e.g., of channels between the UE and NE) based on the measurements. Having the estimated distribution, the NE may use it to generate other elements of the distribution, i.e., the communication channels, or a time evolution of communication channels between the UE and NE, or other characteristics of the wireless communication with the UE. While this embodiment uses the channels or the time evolution of the channels between the UE and the NE as examples of a distribution, other distributions may be used, for example, distributions related to signal detection (recovering desired signals from noise signals observed at the UE). In addition, it is possible that the NE instructs the UE to transmit uplink reference signals, and the NE measures the uplink reference signals and estimates the distribution for generating uplink channels or other elements of the distribution.

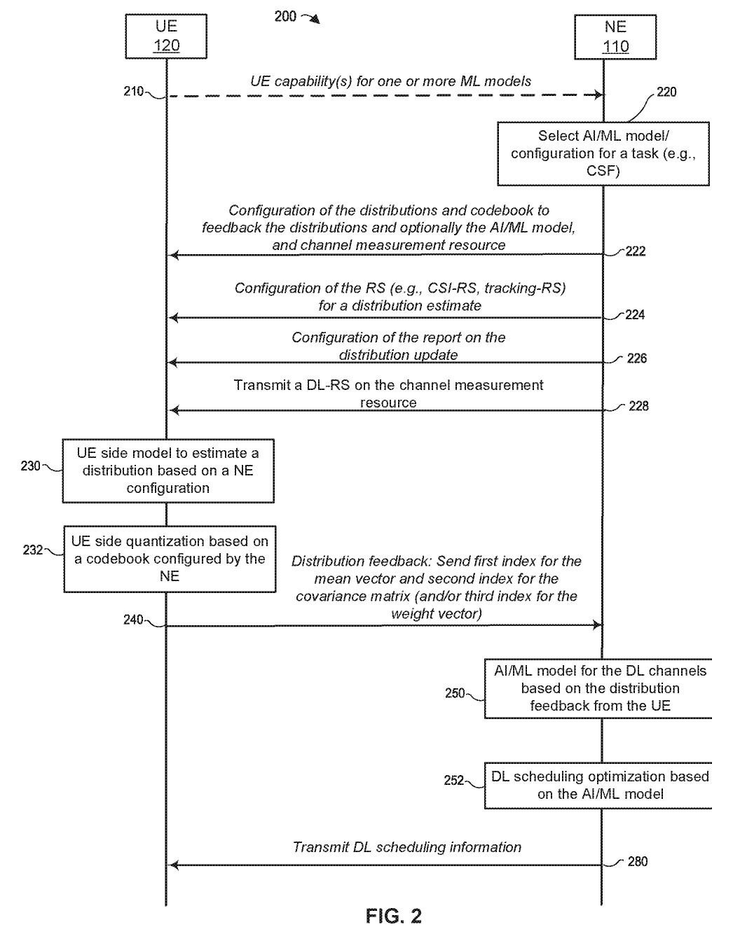

Various scenarios for estimating a distribution at the UE (or NE) and reporting it back to the NE (if estimated at the UE) are discussed with regard to FIGS. 2 to 4. According to an embodiment, a method 200 for estimating a distribution at the UE and reporting it to the NE for DL scheduling is discussed with regard to FIG. 2. The method 200 starts with the UE 120 optionally transmitting 210 to the NE 110 a UE capability for one or more ML models. The capability may include what distributions the UE can generate, for example, Gaussian, or Gaussian mixture or another distribution. In one embodiment, the UE 120 indicates a dimension of the underlining distribution that the UE can support. If the UE supports a Gaussian mixture, the UE can also report capabilities on a number of components in the Gaussian mixture, i.e., the individual Gaussian distributions, which are part of the Gaussian mixture, that the UE can estimate. In one embodiment, the UE reports what ML model is supported at the UE.

The NE 110 selects 220 which ML model to use (at the NE side, but also possible at the UE side) and a corresponding distribution for performing a desired task, for example, channel state feedback (CSF). The CSF may include various types of data/parameters, for example, channel quality indicator (CQI), rank indicator (RI), precoding matrix indicator (PMI), layer indicator (LI), and/or channel state information (CSI) feedback. The CQI indicates the overall channel quality and is used to determine the best modulation and coding scheme (MCS) for transmission. The RI specifies how many independent data streams (layers) the UE can support in MIMO transmission. The PMI provides feedback on the best precoding matrix for beamforming DL signals to the UE. The CSI feedback uses CSI-reference signals (CSI-RS) to estimate the channel and helps the NE manage and allocate radio resources. The CSF is used in 5G for various tasks such as adaptive modulation and coding (e.g., using CQI), beamforming optimization (e.g., using PMI) for maximizing signal strength, massive MIMO scheduling (e.g., using RI and LI), and handover and mobility management (e.g., using CSI feedback). By selecting the ML model at the NE, the NE is capable to predict channel conditions and thus, to reduce the need for frequent feedback from the UE.

The NE 110 then transmits 222 to the UE 120 one or more configurations of the distributions and codebook so that the UE 120 is enabled to measure, estimate, and report (provide feedback) the distributions. In one embodiment, the UE 120 is configured to quantify the underlying distribution at the UE side. Optionally, the NE 110 transmits 222 to the UE 120 the ML model (or an indication or identifier of this model) selected by the NE in step 220. If the distribution to be estimated by the UE is the Gaussian distribution, the NE 110 may configure the codebook used for the mean vector feedback and covariance matrix feedback, respectively. As the mean vector and the covariance matrix association with the Gaussian distribution are known in statistics, their description is omitted in this document. For this case, the UE 120 may report 240 an index for the mean vector (from a codebook1) and another index for the covariance matrix (from a codebook2). If the distribution is a Gaussian mixture, the UE 120 may further transmit 240 the codebook used to quantize the weight vector associated with the Gaussian mixture. In one embodiment, the UE 120 uses a scalar quantization for the transmitting 240 for each element of the weight vector.

The NE 110 also transmits 224 a configuration of the DL reference signals (RSs), such as CSI-RSs or tracking-RSs (TRSs) that the UE 120 can use to estimate the distributions. The NE 110 further transmits 226 one or more configurations on how the UE 120 reports the estimated distribution. For example, the one or more configurations specifies a time and frequency (e.g., resource block (RB)) and spatial resources to be used by the UE to report the estimated one or more distributions. Alternatively, or in addition, the one or more configurations specify the use of a radio resource control (RRC), medium access control control element (MAC-CE), or an uplink control information (UCI) for reporting the estimated one or more distributions.

After receiving these configurations and after receiving 228 a DL-RS on a channel measurement resource specified/configured by the NE 110, the UE 120 estimates 230 the one or more distributions configured by the NE 110. In one embodiment, the UE may determine the distribution by running its own ML model (e.g., DNN) with DL-RS measurements as input. In one embodiment, the DNN (or associated identifier) is transmitted by the NE 110 in step 222. In one embodiment, a new dedicated reference signal (e.g., distribution_feedback_RS) may also be configured by the NE 110 to help the UE 120 to measure and estimate a desired distribution. Alternatively, or in addition, the UE 120 may also use a sample mean and a sample covariance matrix to estimate the mean and covariance, respectively. As noted above, each ML model selected 220 by the NE 110 may have its specific distribution configuration.

In an effort to reduce overhead, the UE determines 232 to use a quantization (also called an “indication”) based on a codebook for reporting the estimated distribution. The codebook for this quantization may be configured by the NE 110. This means that instead of sending raw data determined or measured or estimated at the UE, the UE associates the determined data with an entry (e.g., the above introduced “indication”) of a configured codebook, and sends to the NE the indication (entry of the codebook) of the raw data, and not the raw data. By using the same codebook, the NE is able to extract the corresponding raw data from the codebook, based on the received indication.

As mentioned above, the UE 120 transmits 240 to the NE 110 an indication of the estimated distribution, for example, by using a first index for the mean vector and a second index for the covariance matrix. In one embodiment, the UE 120 also transmits a third index for the weight vector. In one embodiment, one or more of the indexes are associated with various characteristics of the estimated distribution. This means that a table of indexes is configured by the NE and stored at both the UE and NE. After the UE estimates the distribution and determines the associated parameters of the distribution, the UE selects the corresponding entries from the table and transmits to the NE a table index associated with those entries, i.e., the UE uses the quantization process. Note that in one example, the entries in the table may be the first to third indexes, and the table index points to the one or more of the first to third indexes. When the NE receives the table index, the NE extracts the associated one or more of the first to third indexes and, based on this information, the NE determines the estimated distribution.

The NE 110 applies 250 the ML model, selected in step 220, to the estimated distribution received in step 240, to generate the DL channels from the NE 110 to the UE 120. That is, the estimated distribution is the input to the ML model and the output of the ML model is the DL channels. The NE may use various types of ML models, for example, a generative model, or a distribution model, etc. Based on the generated DL channels, the NE 110 optimizes or calculates or determines 252 a DL scheduling. The DL scheduling is then transmitted 280 to the UE 120. The DL scheduling may be related to allocating time and/or frequency resources for DL communication, allocating a number of layers for DL MIMO communication, etc.

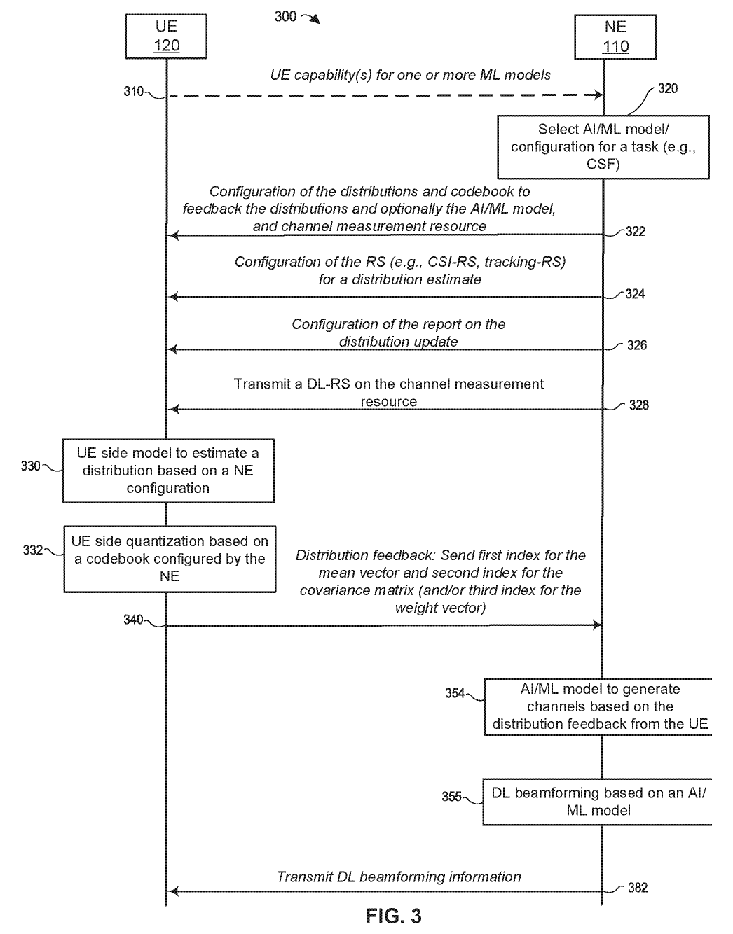

The method discussed with regard to FIG. 2 uses the distribution feedback (indication) from the UE 120 to optimize, at the NE, the DL scheduling with the UE. The method 300 illustrated in FIG. 3 uses the distribution feedback (indication) for DL beamforming. Steps 310 to 340 in FIG. 3 are similar to steps 210 to 240 in FIG. 2, and thus, their description is omitted. The NE 110 applies 354 the ML model selected in step 320 to generate channels between the NE and the UE 120, based on the indication of the estimated distribution received in step 340. In one embodiment, the ML model at the NE 110 generates 354 new channels, for which not enough information was available prior to receiving the indication of the distribution in step 340. Based on the generated new channels, the NE 110 calculates 355 one or more parameters for DL beamforming (for example, with zero-forcing beamforming) and then transmits 382 DL beamforming information to the UE 120 for configuring the UE for DL communication using the beams.

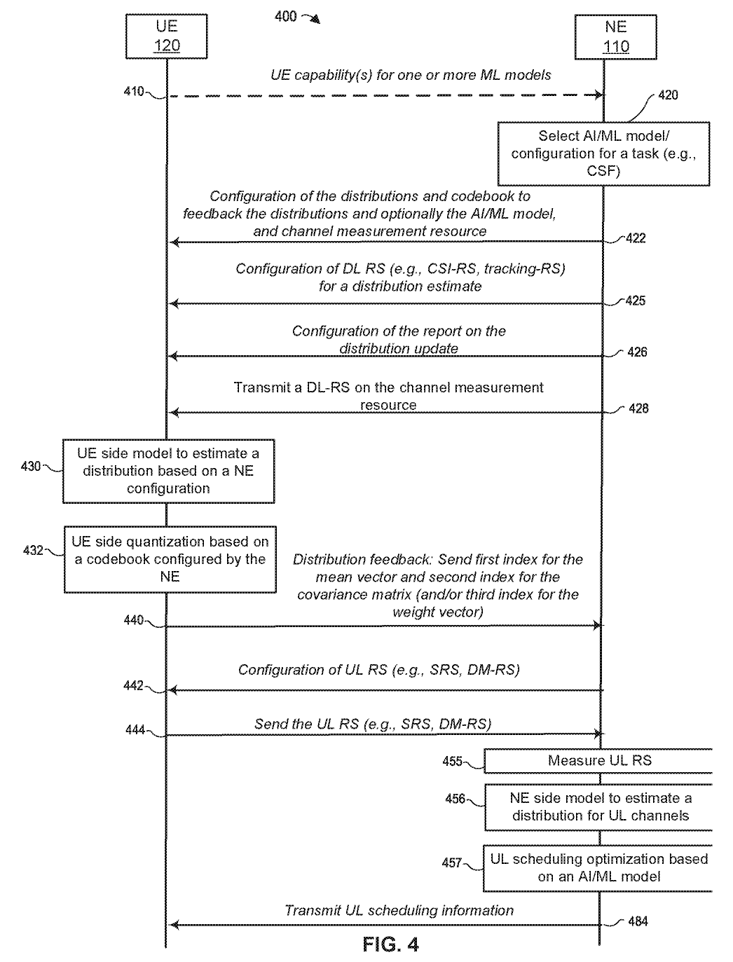

The method 400 illustrated in FIG. 4, different from the methods 200 and 300, uses the distribution feedback (indication) for UL scheduling. Steps 410 to 440 in FIG. 4 are similar to steps 210 to 240 in FIG. 2 and steps 310 to 340 in FIG. 3, and thus, their description is omitted. Different from the methods 200 and 300, the NE 110 transmits 442 to the UE 120, a configuration of a UL RS (e.g., sounding reference signal (SRS) and/or demodulation reference signal (DM-RS)). The UE 120, in response to the received UL RS configuration, transmits 444 one or more UL RS to the NE 110. The UL RS may be a sounding reference signal (SRS) and/or a demodulation reference signal (DM-RS). The NE 110 measures 455 the received UL RS, and based on these measurements, applies 456 the ML model selected in step 420, to generate a UL channels distribution. In one embodiment, the ML model at the NE 110 schedules 457 UL channels, for which not enough information was available prior to measuring the UL RS in step 455. The NE 110 transmits 484 the UL scheduling information to the UE 110. The UL scheduling may be related to allocating time and/or frequency resources for UL communication, allocating a number of layers for UL MIMO communication, allocating UL transmission power, etc.

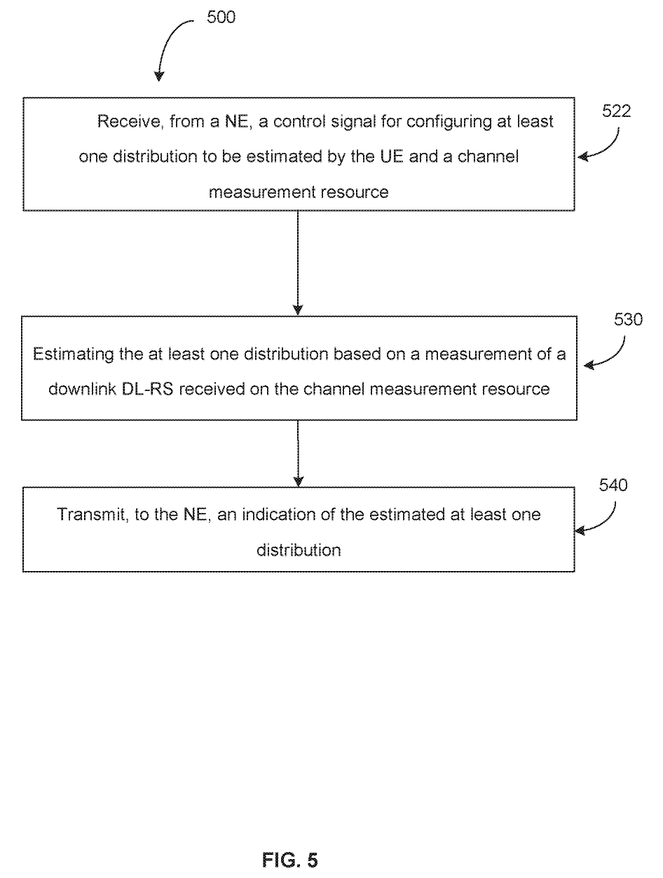

A method 500 for wireless communication by a UE 120 for estimating and reporting the distribution to the NE 110 is discussed with regard to FIG. 5. The method 500 starts by receiving 522, from the NE 110, a control signal for configuring at least one distribution to be estimated by the UE 120, and a channel measurement resource. The UE then estimates 530 the at least one distribution based on measuring a downlink reference signal, DL-RS, received on the channel measurement resource. The UE 120 transmits 540, to the NE 110, an indication of the estimated at least one distribution.

In one embodiment, the step of receiving 522 may further include receiving at least one of: a codebook associated with the at least one distribution, a configuration of the DL-RS to be measured for estimating the at least one distribution, a report configuration for transmitting the indication, or an ML model for estimating the at least one distribution. The method 500 may further include quantizing the estimated at least one distribution based on a codebook, where the indication is associated with the quantized estimate of the at least one distribution. In one embodiment, the indication includes a first index of a mean vector and a second index for a covariance matrix, where the mean vector and the covariance matrix are associated with the at least one distribution. In another embodiment, the indication may further include a third index of a weight vector associated with a Gaussian mixture distribution.

The at least one distribution is associated with at least one of: multiple-input multiple-output channel, beam management, or channel prediction. The DL-RS is one of: a CSI-RS, a tracking-RS, or a distribution feedback-reference signal, DF-RS. The method may further include receiving, from the NE, an uplink reference signal, UL-RS configuration, and transmitting, to the NE, a UL-RS according to the UL-RS configuration. In one embodiment, the at least one distribution is one of: a Gaussian distribution or a Gaussian mixture. The method may further include transmitting a capability associated with an ML model, and/or estimating the at least one distribution with the ML model at the UE.

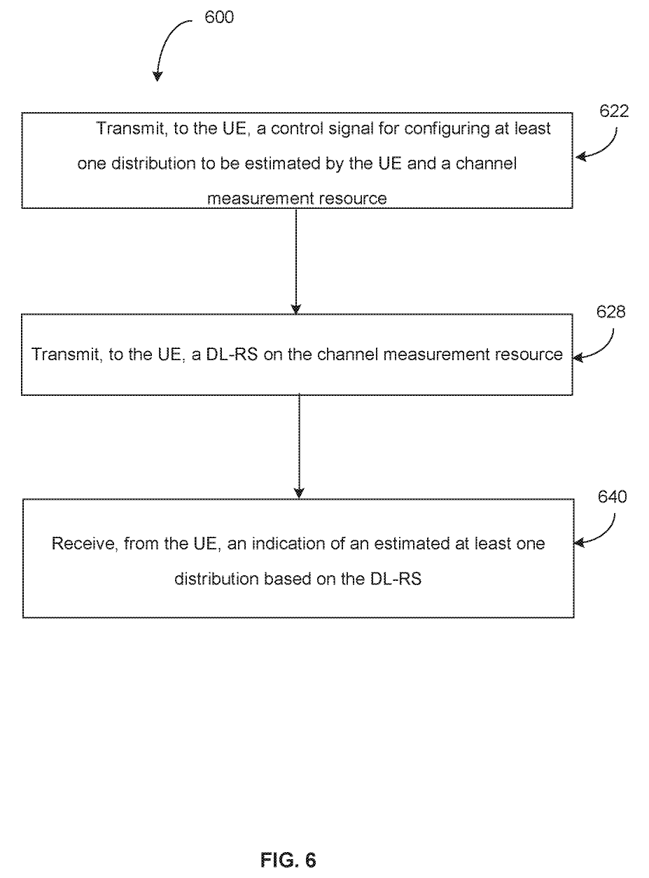

A method 600 for wireless communication by the NE 110, for receiving the distribution or an indication of the distribution from the UE 120, and using the distribution for DL scheduling, MIMO processing, beam management, etc., is discussed with regard to FIG. 6. The NE 110 transmits 622, to the UE 120, a control signal for configuring at least one distribution to be estimated by the UE 120 and a channel measurement resource. The NE 110 transmits 628, to the UE 120, a downlink reference signal, DL-RS, on the channel measurement resource. The NE 110 receives 640, from the UE 120, an indication of an estimated at least one distribution based on the DL-RS. The NE 110 may further select an ML model associated with a task and select the at least one distribution as a function of the task.

In one embodiment, the task is related to one of: determining multiple-input multiple-output channels, determining a beam direction, or predicting a channel. The indication may include a first index of a mean vector and/or a second index for a covariance matrix, where the mean vector and the covariance matrix are associated with the at least one distribution. In one embodiment, the indication further includes a third index of a weight vector associated with a Gaussian mixture distribution.

The method may also include transmitting, to the UE, at least one of: a codebook associated with the at least one distribution, a configuration of a reference signal to be measured by the UE for estimating the at least one distribution, a report configuration to be used by the UE for transmitting the indication, or an ML model selected for the UE to estimate the at least one distribution. The method may further include performing, based on the selected ML model and the indication, at least one of: scheduling a downlink transmission, scheduling an uplink transmission, or performing beam management.

The at least one distribution is one of a Gaussian distribution or a Gaussian mixture. The method may also include receiving, from the UE, a capability about a machine learning model. In one embodiment, the method includes configuring an uplink reference signal, UL-RS, to be transmitted by the UE, receiving, from the UE, the UL-RS, and based on the received UL-RS, estimating, using an ML model, a distribution associated with uplink channels.

The embodiment descriptions in this section refer to the accompanying drawings. The same reference numbers in different drawings identify the same or similar elements. The detailed descriptions do not preclude other embodiments within the scope of the appended claims. The embodiments are not limited to the above-described configurations but may be extended to other arrangements.

Reference throughout this section to “one embodiment” or “an embodiment” means that a particular feature, structure, or characteristic described in connection with an embodiment is included in at least one embodiment. Thus, the appearances of the phrases “in one embodiment” or “in an embodiment” in various places throughout the specification are not necessarily all referring to the same embodiment. Further, the particular features, structures or characteristics may be combined in any suitable manner in one or more embodiments.

Numerical adjectives “first”, “second”, and “third” do not imply any order (are not ordinals) but are markers to distinguish separate instances of similar elements. References to the singular (e.g., “a” or “an”, “the”) should include the plural unless clearly indicated otherwise.

As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

Although the features and elements of the present embodiments are described in the embodiments in particular combinations, each feature or element can be used alone without the other features and elements of the embodiments or in various combinations with or without other features and elements disclosed herein. The methods or flowcharts may be implemented in a computer program, software or firmware tangibly embodied in a computer-readable storage medium for execution by a specifically programmed computer or processor.

What is claimed is:

1. A method for wireless communication by a user equipment, UE, the method comprising:
receiving, from a network entity, NE, a control signal for configuring at least one distribution to be estimated by the UE and a channel measurement resource;
estimating the at least one distribution based on measuring a downlink reference signal, DL-RS, received on the channel measurement resource; and
transmitting, to the NE, an indication of the estimated at least one distribution.

2. The method of claim 1, wherein the receiving further comprises receiving at least one of:
a codebook associated with the at least one distribution,
a configuration of the DL-RS to be measured for estimating the at least one distribution,
a report configuration for transmitting the indication, or
a machine learning, ML, model for estimating the at least one distribution.

3. The method of claim 1, further comprising:
quantizing the estimated at least one distribution based on a codebook,
wherein the indication is associated with the quantized estimate of the at least one distribution.

4. The method of claim 1, wherein the at least one distribution is a Gaussian mixture distribution, and wherein the indication comprises a first index of a mean vector, a second index for a covariance matrix, and a third index for a weight factor, wherein a combination of the mean vector, the covariance matrix, and the weight factor represents a plurality of distinct multi-path channel components of the Gaussian mixture distribution.

5. The method of claim 4, wherein the Gaussian mixture distribution is estimated by the UE as a sum of distinct Gaussian distributions, and wherein the weight factor represents a relative weight for each of the plurality of distinct Gaussian distributions within the Gaussian mixture distribution.

6. The method of claim 1, wherein the at least one distribution is associated with at least one of:
multiple-input multiple-output channel,
beam management, or
channel prediction.

7. The method of claim 1, further comprising:
transmitting a capability associated with supporting at least one of:
a machine learning, ML, model,
a distribution type associated with the at least one distribution, or
a reference signal type associated with the channel measurement resource.

8. The method of claim 1, further comprising:
estimating the at least one distribution with a machine learning, ML, model at the UE.

9. A user equipment, UE, comprising:
a transceiver;
a processor; and
computer-readable storage media storing executable instructions for causing the processor to:
receive, from a network entity, NE, a control signal for configuring at least one distribution to be estimated by the UE and a channel measurement resource;
estimate the at least one distribution based on measuring a downlink reference signal, DL-RS, received on the channel measurement resource; and
transmit, to the NE, an indication of the estimated at least one distribution.

10. The UE of claim 9, wherein the instructions for causing the processor to receive include instructions for causing the processor to receive at least one of:
a codebook associated with the at least one distribution,
a configuration of the DL-RS to be measured for estimating the at least one distribution,
a report configuration for transmitting the indication, or
a machine learning, ML, model for estimating the at least one distribution.

11. The UE of claim 9, wherein the at least one distribution is a Gaussian mixture distribution, and wherein the indication comprises a first index of a mean vector, a second index for a covariance matrix, and a third index for a weight factor, wherein a combination of the mean vector, the covariance matrix, and the weight factor represents a plurality of distinct multi-path channel components of the Gaussian mixture distribution.

12. The UE of claim 11, wherein the Gaussian mixture distribution is estimated by the UE as a sum of distinct Gaussian distributions, and wherein the weight factor represents a relative weight for each of the plurality of distinct Gaussian distributions within the Gaussian mixture distribution.

13. A method for wireless communication by a network entity, NE, the method comprising:
transmitting, to a user equipment, UE, a control signal for configuring at least one distribution to be estimated by the UE and a channel measurement resource;
transmitting, to the UE, a downlink reference signal, DL-RS, on the channel measurement resource; and
receiving, from the UE, an indication of an estimated at least one distribution based on the DL-RS.

14. The method of claim 13, further comprising:
selecting a machine learning, ML, model associated with a task; and
selecting the at least one distribution as a function of the task.

15. The method of claim 13, wherein the task is related to one of:
determining multiple-input multiple-output channels,
determining a beam direction, or
predicting a channel.

16. The method of claim 13, wherein the at least one distribution is a Gaussian mixture distribution, and the indication comprises a first index of a mean vector, a second index for a covariance matrix, and a third index for a weight factor, wherein a combination of the mean vector, the covariance matrix, and the weight factor represents a plurality of distinct multi-path channel components of the Gaussian mixture distribution.

17. The method of claim 13, further comprising:
transmitting, to the UE, at least one of: a codebook associated with the at least one distribution, a configuration of a reference signal to be measured by the UE for estimating the at least one distribution, a report configuration to be used by the UE for transmitting the indication, or a generative model selected for the UE to estimate the at least one distribution.

18. The method of claim 14, further comprising performing, based on the selected ML model and the indication, at least one of:
scheduling a downlink transmission,
scheduling an uplink transmission, or
performing beam management.

19. A network entity, NE, comprising:
a transceiver;
a processor; and
computer-readable storage media storing executable instructions for causing the processor to:
transmit, to a user equipment, UE, a control signal for configuring at least one distribution to be estimated by the UE and a channel measurement resource;
transmit, to the UE, a downlink reference signal, DL-RS, on the channel measurement resource; and
receive, from the UE, an indication of an estimated at least one distribution based on the DL-RS.

20. The NE of claim 19, wherein the at least one distribution is a Gaussian mixture distribution, and the indication comprises a first index of a mean vector, a second index for a covariance matrix, and a third index for a weight factor, wherein a combination of the mean vector, the covariance matrix, and the weight factor represents a plurality of distinct multi-path channel components of the Gaussian mixture distribution.
